(19) United States
(12) Patent Application Publication
(10) Pub. No.: US 2009/0269556 A1
(43) Pub. Date: Oct. 29, 2009

(54) HOUSING, ELECTRONIC DEVICE USING THE HOUSING, AND MANUFACTURING METHOD THEREOF

(75) Inventors: CHE-YUAN HSU, Shindian (TW); FU-KENG YANG, Shindian (TW); CHENG-WEN SU, Shindian (TW); YI-QIANG XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/420,138

(22) Filed: Apr. 8, 2009

(30) Foreign Application Priority Data
Apr. 25, 2008 (CN) 200810301308.4

(51) Int. Cl. B32B 5/00; B32B 37/00

(52) U.S. Cl. 428/195.1; 156/245

(57) ABSTRACT

A housing for an electronic device includes a thin film defining an outer surface having a plurality of impressions, and an inner surface positioned opposite to the outer surface, a decorative coating attached to the inner surface of the thin film; and a substrate attached to the decorative coating. A method for manufacturing the housing and an electronic device using the housing are also disclosed.

### BACKGROUND

1. Technical Field

The present disclosure generally relates to housings, and particularly, to a housing for an electronic device, and a method for making the housing.

2. Description of Related Art

Nowadays, portable electronic device such as mobile phones, laptops and personal digital assistants (PDAs) are widely used. Most housings of portable electronic devices are made by in mold labeling (IML). A typical housing includes a transparent plastic film, an ink coating attached to an inner surface of the transparent plastic film, and a substrate moldingly attached to the ink coating by an insert molding process. The transparent plastic film is wear proof and covers the ink coating, thereby protecting the ink coating from being scratched. In order to be more attractive, the inner surface of the transparent plastic film is coated with 3D ink patterns by overprint processes. However, the housings decorated by the overprint processes may not have genuine three-dimensional effect. Furthermore, the overprint processes are complicated and waste ink.

Therefore, there is room for improvement within the art.

### BRIEF DESCRIPTION OF THE DRAWINGS

Many aspects of the housing for an electronic device can be better understood with reference to the following drawings. The components in the drawings are not necessarily drawn to scale, the emphasis instead being placed upon clearly illustrating the principles of the molded article. Moreover, in the drawings like reference numerals designate corresponding parts throughout the several views.

FIG. 1 is a cross sectional view of a housing.

FIG. 2 is a cross sectional view of a thin film laminated in rollers to make the housing.

### DETAILED DESCRIPTION OF THE DISCLOSURE

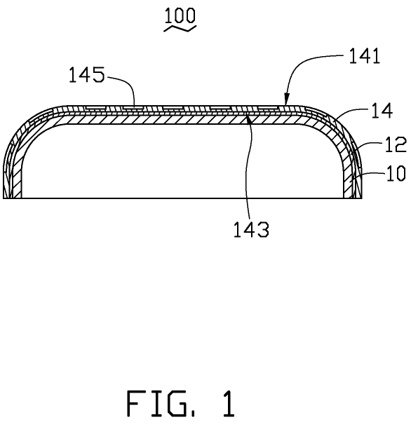

Referring to FIG. 1, an exemplary housing 100 includes a thin film 14, a decorative coating 12 attached to the thin film 14, and a substrate 10 attached to the decorative coating 12.

The thin film 14 is a plastic selected from a group consisting of polycarbonate (PC), polyethylene terephthalate (PET), polymethylmethacrylate (PMMA), or polylactic acid (PLA). The thin film 14 includes an outer surface 141 and an inner surface 143 opposite to the outer surface 141. The outer surface 141 defines a plurality of impressions. According to the exemplary embodiment, the impressions are substantially rectangular slots 145. The inner surface 143 is smooth surface.

The decorative coating 12 is made of ink, and attached to the inner surface 143 of the thin film 14 by screen printing.

The substrate 10 is made of plastic and moldingly attached to the decorative coating 12 by an insert molding process. The substrate 10 can be made of polycarbonate (PC), polyethylene terephthalate (PET), acrylonitrile-butadiene-styrene (ABS), polymethylmethacrylate (PMMA), polyethylene (PE) or polyamide (PA).

During a process for manufacturing the housing 100, the thin film 14 is provided.

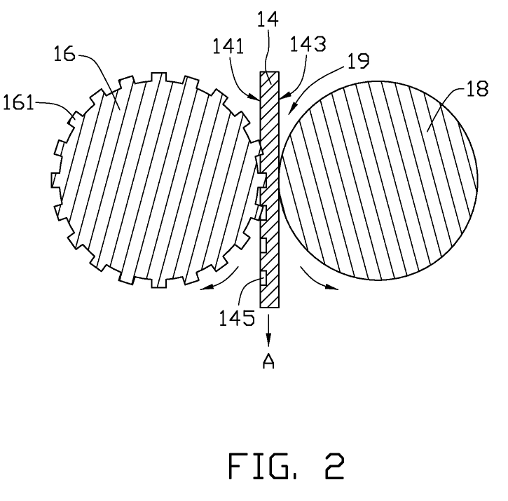

Referring to FIG. 2, A first roller 16 and a second roller 18 are provided. The first roller 16 is gear-shaped and has a plurality of protrusions 161 formed on the outer circumference. The second roller 18 is cylindrical. The first roller 16 rotates in a direction inverse to that of the second roller 18 at the same level. According to the exemplary embodiment, the first roller 16 rotates in a clockwise direction, and the second roller 18 rotates in a counterclockwise direction.

The first roller 16 and the second roller 18 define a gap 19 therebetween. The width of the gap 19 is slightly smaller than the thickness of the thin film 14. The thin film 14 is inserted into the gap 19, and moved along arrow A by the first roller 16 and the second roller 18. The outer surface 141 is laminated by the first roller 16, and the inner surface 143 is laminated by the second roller 18. When the thin film 14 completely passes through the gap 19, a plurality of slots 145 are formed on the outer surface 141 corresponding to the protrusions 161.

The decorative coating 12 is then applied onto the inner surface 143 of the thin film 14 by screen printing.

The thin film 14 having the decorative coating 12 formed thereon is hot pressed to form a predetermined shape of the housing 100 shown in FIG. 1.

An injection mold is provided. The thin film 14 is placed into the injection mold. A substrate 10 is attached to the decorative coating 12 by the injection molding.

The thin film 14 defines a plurality of slots 145 having three-dimensional effect, thereby giving the housing 100 a more attractive appearance. The method for manufacturing the housing 100 is simple, thereby improving productivity.

It should be also understood, the housing 100 is a part of an electronic device, and configured for using on the electronic device.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing for an electronic device, comprising:
a thin film defining an outer surface having a plurality of impressions, and an inner surface positioned opposite to the outer surface;
a decorative coating attached to the inner surface of the thin film; and
a substrate attached to the decorative coating.

2. The housing as claimed in claim 1, wherein the thin film is made of plastic and made by an insert molding process.

3. The housing as claimed in claim 2, wherein the thin film is selected from a group consisting of polycarbonate, polyethylene terephthalate, polymethylmethacrylate, and polylactic acid.

4. The housing as claimed in claim 1, wherein the decorative coating is made of ink applied onto the inner surface of the thin film by screen printing.

5. The housing as claimed in claim 1, wherein the substrate is made of plastic attached to the decorative coating by an insert molding process.

6. The housing as claimed in claim 5, wherein the substrate is made of polycarbonate, polyethylene terephthalate, acrylonitrile-butadiene-styrene, polymethylmethacrylate, polyethylene or polyamide.

7. An electronic device, comprising:
a housing, comprising:
a thin film defining an outer surface having a plurality of impressions, and an inner surface positioned opposite to the outer surface;
a decorative coating attached to the inner surface of the thin film; and
a substrate attached to the decorative coating.

8. The electronic device as claimed in claim 7, wherein the thin film is made of plastic and made by an insert molding process.

9. The electronic device as claimed in claim 8, wherein the thin film is selected from a group consisting of polycarbonate, polyethylene terephthalate, polymethylmethacrylate, and polylactic acid.

10. The electronic device as claimed in claim 7, wherein the decorative coating is made of ink applied onto the inner surface of the thin film by screen printing.

11. The electronic device as claimed in claim 7, wherein the substrate is made of plastic attached to the decorative coating by an insert molding process.

12. The electronic device as claimed in claim 11, wherein the substrate is made of polycarbonate, polyethylene terephthalate, acrylonitrile-butadiene-styrene, polymethylmethacrylate, polyethylene or polyamide.

13. A method for manufacturing a housing for an electronic device, comprising:
providing a thin film;
providing a first roller and a second roller rotating at a direction inverse to the first roller, the first roller and the second roller defining a gap therebetween, at least one of the first roller and the second roller defining a plurality of protusions thereon;
placing thin film into the gap, the thin film laminated by the first roller and the second roller, and defining a plurality of impressions on the thin film;
providing decorative coating attached to a surface defining the impressions; and
providing a substrate attached to the decorative coating.

14. The method as claimed in claim 13, wherein the decorative coating is made of ink.

15. The method as claimed in claim 13, wherein the substrate is made of plastic and attached to the decorative coating by an insert molding process.

16. The method as claimed in claim 15, wherein the thin film having the decorative coating formed thereon is hot pressed to form a predetermined shape of the housing before injecting the substrate to the decorative coating.
